(19) United States
(12) Patent Application Publication
(10) Pub. No.: US 2015/0059857 A1
(43) Pub. Date: Mar. 5, 2015

(54) MULTICHAMBERED VIAL AND METHOD OF MIXING ANALYTICAL REFERENCE MATERIALS

(71) Applicant: RESTEK CORPORATION, Bellefonte, PA (US)

(72) Inventors: Thomas E. KANE, Tyrone, PA (US); Michael A. GOSS, State College, PA (US)

(21) Appl. No.: 14/468,607

(22) Filed: Aug. 26, 2014

Related U.S. Application Data
(60) Provisional application No. 61/870,538, filed on Aug. 27, 2013.

(51) Int. Cl. B01L 3/00; F17D 1/08

(52) U.S. Cl. CPC B01L 3/52; F17D 1/08; B01L 2300/0867; B01L 2300/0832; B01L 2400/0478; B01L 2200/16
USPC 137/1; 422/558

(57) ABSTRACT

A device for transferring and containing liquid and a mixing method are provided. The device includes a vial having at least two storage lumens extending axially along a vial body, a transfer channel coupled to a distal end of each of the storage lumens, and a common chamber in fluid communication with the storage lumens via the transfer channels. The mixing method includes providing the device for transferring and containing liquid material; providing a fluid subunit in each of the storage lumens, a distal gasket sealing each of the fluid subunits from a distal end of the vial; providing a plunger assembly coupled to a proximal end of the vial; and depressing the plunger assembly. Depressing the plunger assembly forces the distal gaskets into the gasket seats and transfers the fluid subunits into the common chamber via the transfer channels.

This application claims priority to, and the benefit of, U.S. Provisional Patent Application No. 61/870,538, filed Aug. 27, 2013, which is hereby incorporated by reference in its entirety.

### FIELD OF THE INVENTION

The present invention is directed to methods and devices for combining and containing liquids. More particularly, the present invention is directed to methods and devices for transferring liquids separately stored within a single container into a common space within the same container.

### BACKGROUND OF THE INVENTION

Analytic reference materials are used as standards in chemical analysis for determining the presence and/or quantity of a particular substance or analyte. Often, the analytic reference materials are contained in glass vials that are hermetically sealed. The vials must be broken in order to access the analytic reference materials, which are then usually withdrawn with a pipette or syringe rather than being poured. The use of vials can suffer from various drawbacks, including that vials can be difficult to open, can result in and/or contaminate a sample with shattered glass, and can be time consuming to empty, among others.

Following opening of the hermetically sealed vial the contents are commonly transferred to a glass sample vial or other container. The vial commonly has a removable and resealable cap for direct access to the liquid. The vial may also employ a septum whereby the contents of the vial may be removed using a syringe needle or other means to penetrate the septum and access the liquid within the vial.

Most analytic reference materials are complex combinations containing many different chemical components. Certain analytic reference materials require multiple chemical compounds of known chemical incompatibility. Placing chemically incompatible compounds in the same vial causes denaturing and degradation of those compounds. The denatured compounds change an analytic reference materials' chemical composition, leading to inaccurate chemical analysis. In some cases, combining compounds that are demonstrated to be aggressively reactive to each other results in a useful shelf life of the combined standard mix on the order of minutes. In these cases it is desirable that all unnecessary transfer steps be completely removed from the process of combining the contents of the vials.

In view thereof, chemically incompatible combinations are often supplied in a kit having multiple vials in order to keep the materials in pristine form until use. However, increasingly complex analytical methods often require an increasing number of components to make up the analytic reference material, resulting in so called “mega” mixes that contain a large number of individual vials in an analysis kit. Each vial contains a single analytic reference material or a combination of chemically compatible analytic reference materials. The kits require the end user to combine the contents of the vials, in correct amounts, to form the final analytic reference materials. These kits suffer from various drawbacks, including the large number of vials which must be combined to form a standard solution. The vials are time consuming to combine, and are prone to end user error during combination. User error, along with chemical degradation, can lead to undesirable chromatographic peaks or other errors in the data collected from various analytical techniques.

One alternative to the multiple vial kits includes a microfluidic cartridge, as described in U.S. Patent Application Publication No. 2011/0020182. The microfluidic cartridge holds multiple liquids in a series of chambers along a common micro-channel. However, when the chambers are positioned in series along a common micro-channel, each successive chamber is positioned further from a final mixing point. As such, the liquids held in the successive chambers do not mix at the same time. Instead, a liquid from a most distal chamber will mix with a liquid from a middle chamber prior to mixing with a liquid from a most proximal chamber. Additionally, each successive chamber will include an increased dead space, such that when the same amount of liquid is released from each of the chambers, the final mixture will include an increased amount of liquid from the most proximal chamber as compared to the others.

In another alternative, in place of the vials, fluids are sometimes stored in pre-filled syringes, as described in U.S. Pat. No. 5,704,918. In general, two individual syringes, each with their own plunger, can be held together and directed to a single output. However, these devices are difficult to handle, are difficult to depress simultaneously, present size constraints, and cannot easily incorporate more than two syringes. Additionally, although each individual syringe typically contains a single liquid therein, some devices include multiple liquids held in series within a single syringe. As a plunger is depressed, the series of liquids within the syringe are released one after the other. These devices suffer from their own attendant drawbacks, including that they are not capable of releasing multiple liquids at the same time and are limited by the length of the syringe.

Syringe-based systems require the dispensed liquids to be contained from the syringe into another vessel, where the combined liquids are ultimately stored as a mixture. An improved invention is described here where the multiple chamber design of a multichamber syringe or vial is combined with the final collection vessel. In this design the liquids are transferred from separate channels into a common (mixed) channel of the same container. This reduces the number of steps required of the operator as well as reduces risks of sample loss or exposure to the operator as a result of transfer from a vial to another vessel.

### BRIEF DESCRIPTION OF THE INVENTION

In one embodiment, a device for transferring and containing liquid material includes a vial having at least two storage lumens extending axially along a vial body, each of the storage lumens having a gasket seat formed therein, a transfer channel coupled to a distal end of each of the storage lumens, and a common chamber in fluid communication with the storage lumens via the transfer channels.

In another embodiment, a device for transferring and containing liquid material includes a vial having at least two storage lumens extending axially along the vial body, each of the storage lumens including a gasket seat formed therein, a transfer channel coupled to a distal end of each of the storage lumens, a common chamber in fluid communication with the storage lumens via the transfer channels, a plunger assembly coupled to a proximal end of the vial, the plunger assembly having at least two pistons, each of the pistons receivable within one of the storage lumens, and an analytic reference material subunit provided in each of the storage lumens, the analytic reference material subunit sealed between a proximal gasket and a distal gasket slidably disposed within the storage lumens. When the distal gasket is seated in the gasket seat, the transfer channel fluidly connects the analytic reference material subunit of the storage lumen to the common chamber.

In another embodiment, a mixing method includes providing a device for transferring and containing liquid material, the device including a vial having at least two storage lumens extending axially along a vial body, each of the storage lumens having a gasket seat and a distal gasket therein, a transfer channel coupled to a distal end of each of the storage lumens, and a common chamber in fluid communication with the storage lumens via the transfer channels; providing a fluid subunit in each of the storage lumens, the distal gasket sealing each of the fluid subunits from a distal end of the vial; providing a plunger assembly coupled to a proximal end of the vial, the plunger assembly being in communication with the storage lumens; and depressing the plunger assembly. The depressing of the plunger assembly forces the distal gaskets into the gasket seats and transfers the fluid subunits into the common chamber via the transfer channels.

An advantage of exemplary embodiments is that each of the storage lumens in the vial isolates the material subunit contained therein, ensuring that chemically incompatible compounds composing a mixed solution are not stored together.

Another advantage is that the vial is capable of equivalently containing the fluid subunits in the storage lumens as a single mixture at or just prior to the point of use.

Still another advantage is that the device decreases liquid dead volume, which maximizes the volume of material subunits transferred.

Yet another advantage is that the device provides an equivalent liquid dead volume for each of the material subunits contained within the storage lumens.

A further advantage is that a single step both mixes and dispenses the material subunits to form the mixed solution, thus decreasing the number of steps required of the end user, which decreases or eliminates the risk of error commonly associated with multiple liquid transfers.

Another advantage is that the decreased number of steps required of the end user decreases the time required for use, decreases user error, and/or decreases a risk of contamination.

Yet another advantage is that the isolated material subunits can be combined and transferred to a common chamber with breaking individual vials, thus decreasing or eliminating an amount of broken glass.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a side view of a standard liquid container, or vial.

FIG. 2 is a lateral cross-sectional view of an exemplary vial having a plurality of lumens according to an embodiment of the disclosure having two storage lumens.

FIG. 3 is a lateral cross section view of the vial of FIG. 2 containing fluid according to an embodiment of the disclosure.

FIG. 4 is a radial cross section view showing a distal end of an exemplary vial having a common chamber according to an embodiment of the disclosure.

FIG. 5 is a radial cross section view of an exemplary vial showing a mixing channel according to an embodiment of the disclosure.

FIG. 6 is a radial cross section view showing a transfer channel of an exemplary vial having two storage lumens according to an embodiment of the disclosure.

FIG. 7 is a radial cross section view showing a proximal end of an exemplary vial having two storage lumens according to an embodiment of the disclosure.

FIG. 8 is a radial cross section view showing a distal end of an exemplary vial having a common chamber according to an embodiment of the disclosure having twelve storage lumens.

FIG. 9 is a radial cross section view of an exemplary vial showing a mixing channel according to an embodiment of the disclosure.

FIG. 10 is a radial cross section view showing a transfer channel of an exemplary vial having twelve storage lumens according to an embodiment of the disclosure.

FIG. 11 is a radial cross section view showing a proximal end of an exemplary vial having twelve storage lumens according to an embodiment of the disclosure.

FIG. 12 is a lateral cross-sectional view of a transferring and containing device according to an embodiment of the disclosure.

FIG. 13 is a lateral cross-sectional view of the device of FIG. 12 after depression of a plunger.

FIG. 14 is a lateral cross-sectional view of the device of FIG. 13 after removal of the plunger.

FIG. 15 is a cutaway side view of a vial body prior to mixing material subunits according to an embodiment of the disclosure.

FIG. 16 is a cutaway side view of a vial body during the mixing of the material subunits according to an embodiment of the disclosure.

FIG. 17 is a lateral cross-sectional view of an exemplary vial having a plurality of lumen according to an embodiment of the disclosure having two storage lumens, where the collection channel is positioned coaxially between the transfer channels and storage lumens array.

FIG. 18 is a radial cross section view showing a distal end of an exemplary vial having a common chamber according to an embodiment of the disclosure.

FIG. 19 is a radial cross section view of an exemplary vial showing a transfer channel array connected to a common chamber according to an embodiment of the disclosure.

FIG. 20 is a radial cross section view showing a common chamber of an exemplary vial having two storage lumens according to an embodiment of the disclosure.

FIG. 21 is a radial cross section view showing a proximal end of an exemplary vial having two storage lumens according to an embodiment of the disclosure.

FIG. 22 is a radial cross section view showing a distal end of an exemplary vial having a common chamber according to an embodiment of the disclosure.

FIG. 23 is a radial cross section view of an exemplary vial showing a transfer channel array connected to a common chamber according to an embodiment of the disclosure.

FIG. 24 is a radial cross section view showing a common chamber of an exemplary vial having twelve storage lumens according to an embodiment of the disclosure.

FIG. 25 is a radial cross section view showing a proximal end of an exemplary vial having twelve storage lumens according to an embodiment of the disclosure.

FIG. 26 is a lateral cross-sectional view of a transferring and containing device according to an embodiment of the disclosure.

FIG. 27 is a lateral cross-sectional view of the device of FIG. 26 after depression of a plunger.

FIG. 28 is a lateral cross-sectional view of the device of FIG. 27 after removal of the plunger.

FIG. 29 is a lateral cross section view of an exemplary vial containing fluid according to an embodiment of the disclosure where the transfer channels are positioned in-line with the gasket seats.

FIG. 30 is a radial cross section view showing a distal end of an exemplary vial having a common chamber according to an embodiment of the disclosure.

FIG. 31 is a radial cross section view of an exemplary vial showing a transfer channel array connected to a common chamber according to an embodiment of the disclosure.

FIG. 32 is a radial cross section view showing a common chamber and a transfer array of an exemplary vial having two storage lumens according to an embodiment of the disclosure.

FIG. 33 is a radial cross section view showing a proximal end of an exemplary vial having two storage lumens according to an embodiment of the disclosure.

FIG. 34 is a cutaway side view of a vial body prior to mixing the material subunits according to an embodiment of the disclosure.

FIG. 35 is a cutaway side view of a vial body during the mixing of the material subunits according to an embodiment of the disclosure.

Wherever possible, the same reference numbers will be used throughout the drawings to represent the same parts.

### DETAILED DESCRIPTION OF THE INVENTION

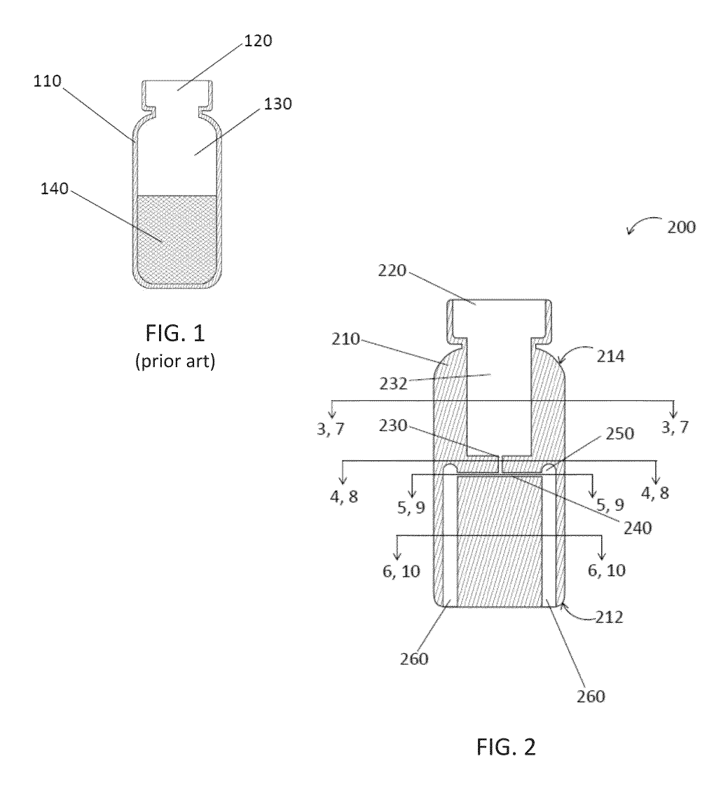

FIG. 1 illustrates a representative example of a standard vial. The walls of the standard vials 110 are commonly made of glass or plastic, with a standard vial mouth or opening 120 shaped to receive either a screw cap or crimp-based cap. The liquid contents 140 of the standard vial are contained in a single interior volume 130.

Referring to FIG. 2, a vial 200 includes a vial body 210 having a common chamber 232 and a plurality of storage lumens 260 formed therein. The plurality of storage lumens 260 extend axially along the length of the vial body 210, from a proximal end 212 towards a distal end 214 of the vial 200. The common chamber 232 acts as a reservoir for contents contained within the plurality of storage lumens 260. The reservoir formed by the common chamber 232 includes sufficient volume to contain at least the contents of the storage lumens 260, as well as any additional solvents or additives provided directly in the common chamber 232. A vial opening 220 extends outwardly from the distal end 214, the vial opening providing access to at least a portion of the vial contents within the common chamber 232. For those skilled in the art, the vial opening 220 may be covered with a cap or cover. The cover may include a septum or other pierceable device whereby a portion of the vial contents in common chamber 232 may be accessed using a syringe needle or other sampling device.

The vial body 210 may be manufactured from any suitable material and may advantageously be formed of borosilicate glass. It will be appreciated, however, that other glass and plastic materials may also be employed. Depending on the materials of construction and/or the intended contents of the vial, the inner, outer or both surfaces of the vial 200, and particularly the surfaces of the storage lumens 260 exposed to the vial contents, may be chemically deactivated or otherwise treated to reduce surface reactivity and reduce solvent adsorption prior to filling.

In one embodiment, transfer channels 240 couple the storage lumens 260 to a mixing channel 230 which is connected to the common chamber 232. In another embodiment, a separate transfer channel 240 is provided for each individual storage lumen 260. In a further embodiment, each of the storage lumens is equidistant from the common chamber 232. The transfer channels 240 and the mixing channel 230 provide fluid communication between the storage lumens 260 and the common chamber 232.

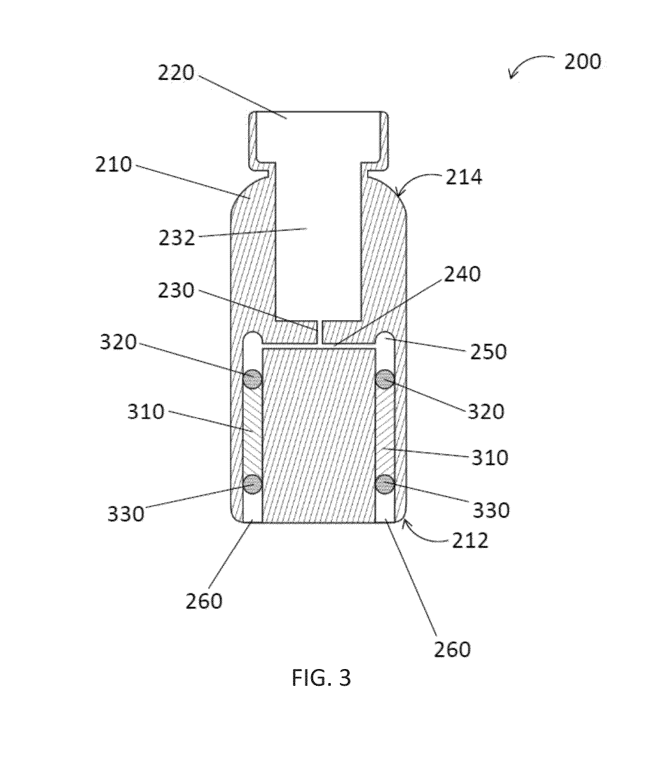

Referring to FIG. 3, at least one individual storage lumen 260 houses a material subunit, such as, but not limited to, an analytic reference material subunit 310. For example, in one embodiment, each of the individual storage lumens 260 houses at least one of the analytic reference material subunits 310. The size and/or geometry of the storage lumens 260, including their length and diameter, may depend upon the number of storage lumens 260 and the total volume needed for the analytical reference material subunits 310 required to make up a particular analytical reference material, as well as the overall ease of use of the transferring and containing device. For example, in another embodiment, the storage lumens 260 are cylindrical, and have a diameter of between about 0.001 inches and about 0.5 inches, between about 0.001 inches and about 0.25 inches, between about 0.001 inches and about 0.1 inches, between about 0.01 inches and about 0.06 inches, between about 0.01 inches and about 0.04 inches, between about 0.04 inches and about 0.06 inches, or any combination, sub-combination, range, or sub-range thereof. Other suitable storage lumens 260 include any geometry for housing the material subunit 310 therein. Although illustrated as including a similar shape, length, and diameter, the size and/or geometry of each storage lumen 260 may be equal to, or dissimilar from, one or more of the other storage lumens 260.

The analytic reference material subunits 310 are typically liquid and may comprise a component that is itself in liquid form or a suspension, dispersion, emulsion or solution of one or more components in a liquid carrier. The storage lumens 260 may be filled with the analytical reference material subunits 310 during manufacture either manually, such as by using a hand-held syringe, or through automated processing techniques. While illustrated here as having the same volume, as one skilled in the art will appreciate, each storage lumen 260 may contain a different volume of analytic reference material subunit 310 depending upon the requirements of the final analytic reference material. It will further be appreciated that with respect to FIG. 3 and other cross-sectional views, the different cross-hatching is for purposes of showing different elements and is not intended to refer to any specific materials of construction.

Each analytic reference material subunit 310 is sealed on the proximal end 212 of each storage lumen 260 by a proximal gasket 330, and on the distal end 214 of each storage lumen 260 by a distal gasket 320. The proximal gaskets 330 and the distal gaskets 320 are of any suitable size, shape and construction and include any solid object that is sealably inserted and slidably disposed within the storage lumen 260. It will be appreciated that the characteristics of the proximal gaskets 330 may be the same or different from those of the distal gaskets 320 and further that the characteristics of all distal (or proximal) gaskets 320 are also not necessarily the same, for example, in the event that one storage lumen 260 has a diameter larger than that of another.

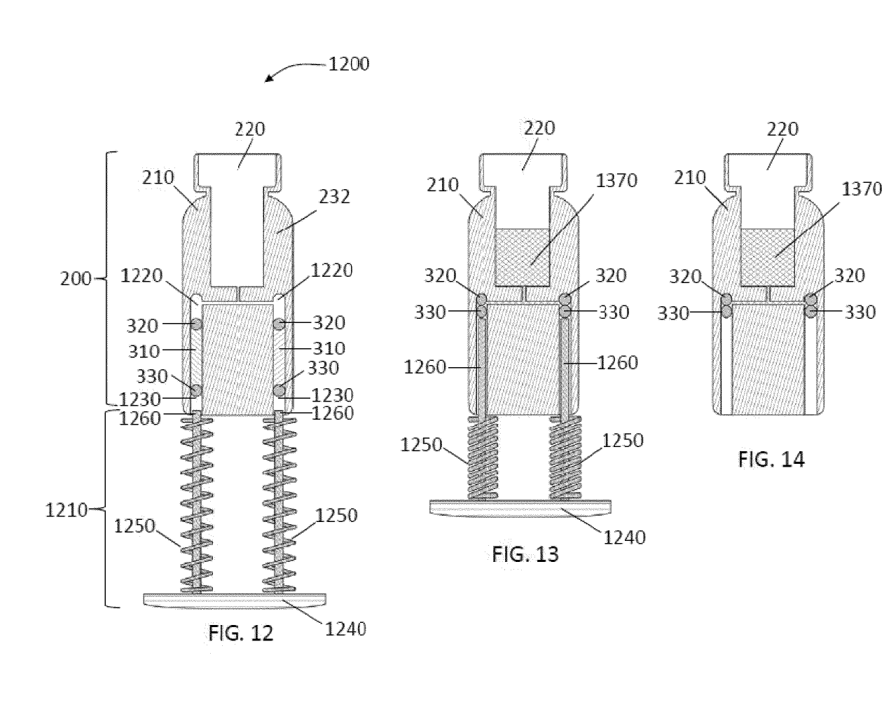

In one embodiment, the contents of the storage lumens 260 are transferred through the transfer channels 240 to the mixing channel 230, and from the mixing channel 230 into the common chamber 232. As used herein, the term ‘transferred’ and variations thereof relate to the movement of the contents of the storage lumens 260 to a mass collection chamber within the same vial. Prior to reaching the mixing channel 230, the analytic reference material subunit 310 sealed between the proximal gasket 330 and the distal gasket 320 in each of the individual storage lumens 260 is isolated from the analytic reference material subunits 310 within the other storage lumens 260. As the analytic reference material subunits 310 are moved towards the distal end 214, as described in further detail herein with regard to FIGS. 12-14, gasket seats 250 in the storage lumens 260 receive the distal gaskets 320. The contents of the storage lumens 260 flow past the distal gaskets 320 seated in the gasket seats 250, into the transfer channels 240, and are combined in the mixing channel 230 and/or the common chamber 232. The combined contents are then contained in the common chamber 232 as a mixture which is available for sampling through a vial opening 220 that extends outwardly from the distal end 214.

The distal gaskets 320 are typically spherical or otherwise have a rounded surface, which can aid in the smooth transition of liquid from the storage lumens 260 to the transfer channels 240 when the distal gasket 320 is seated in the gasket seat 250. Preferably, the gaskets 320, 330 are constructed of an inert material or are otherwise treated so as not to react with the components of the analytic reference material subunits 310 they contain. Exemplary materials include semi-pliable materials having non-reactive surfaces, such as polyether ether ketone (PEEK), hard silicone, fluoropolymers, and particularly polytetrafluoroethylene (PTFE).

In one embodiment, the proximal and distal gaskets 330, 320 are both made of Teflon, have a spherical shape and are slightly larger in diameter than the storage lumens 260. In this manner, the proximal gaskets 330 and distal gaskets 320 are sized with respect to the storage lumen to provide enough force on the storage lumen 260 to seal it and prevent the analytic reference material subunits 310 from leaking However, the proximal gaskets 330 and distal gaskets 320 are still slidably disposed within the storage lumens 120 to be moved when a pressure is applied, which may vary depending on a variety of factors, including the elastic modulus of the material used for the gasket and/or the vial body 210. For example, in one embodiment, Teflon balls having a diameter of 0.0625 inches can be used as proximal and distal gaskets 330, 320 in a storage lumen 260 having an internal diameter of 0.0600 inches.

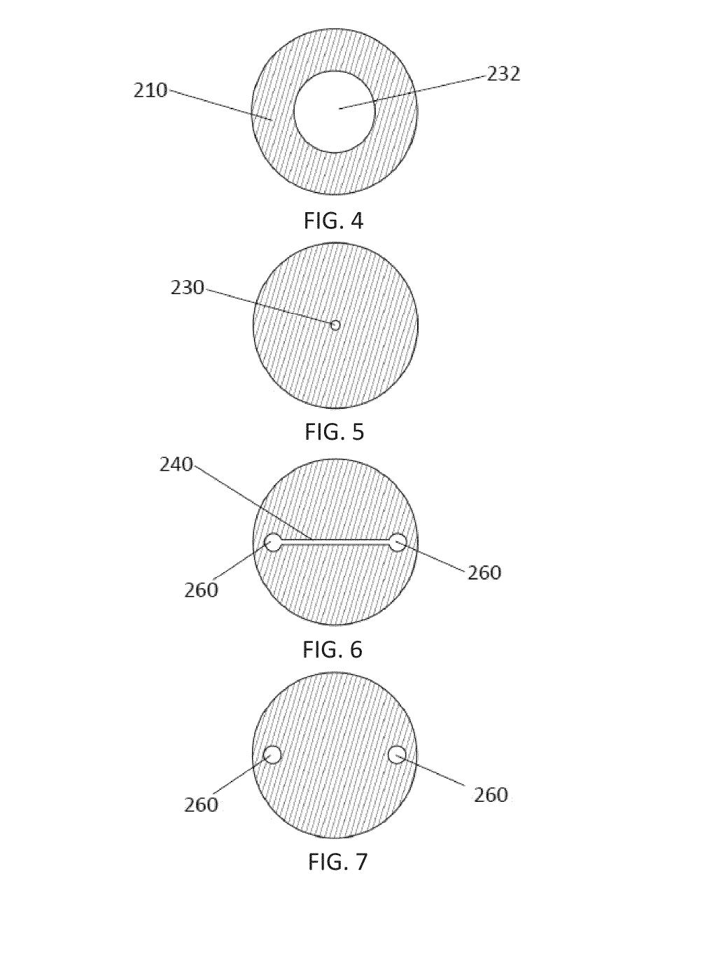

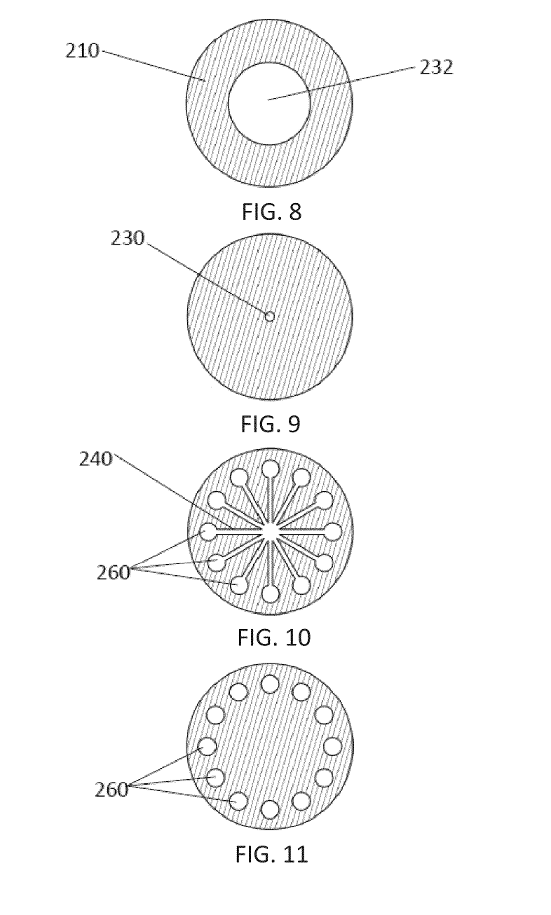

Turning to FIGS. 4-7, in one embodiment, the vial 200 includes two of the individual storage lumens 260. In another embodiment, as illustrated in FIGS. 8-11, the vial 200 includes twelve of the individual storage lumens 260. The cross-sectional views shown in FIGS. 4-7 and 8-11 are taken from the same position along the vial body 210. Specifically, FIGS. 4 and 8 show a cross-section of the common chamber 232 near the distal end 214 of the vial 200; FIGS. 5 and 9 show a cross-section of the mixing channel 230 extending between the common chamber 232 and the transfer channels 240; FIGS. 6 and 10 show a cross-section of the transfer channels 240 extending from the lumens 260 to the mixing channel 230; and FIGS. 7 and 11 show a cross-section of the storage lumens 260 near the proximal end 212 of the vial 200.

Although illustrated with two or twelve of the lumens 260, it will be appreciated by those skilled in the art that the vial 200 is not so limited. For example, in other embodiments, the vial 200 may contain any odd or even number of the storage lumens 260. In many cases, certain chemical components used in analytic reference material solutions are chemically benign with respect to each other and may be present in the same solvent with no ill effects. In this case it is not always necessary to employ a vial having the same number of lumens as there are chemical compounds in the analytic reference material standard solution; the minimum number of discrete vial lumens is preferably greater than the smallest number of analytic reference material solution subunits necessary to minimize or eliminate unwanted component-component chemical interactions. A maximum number of the storage lumens 260 within the vial 200 will largely depend on how many lumens will reasonably fit, given an inner diameter of the storage lumens 260 and an outer diameter of the vial body 210.

Referring to FIGS. 12-14, a transferring and containing device 1200 is shown in various steps of use as a plunger assembly 1210 is depressed. The plunger assembly 1210 is coupled to the vial 200, and provides a mechanism by which the analytic reference material subunits 310 are expelled from the storage lumens 206 and ultimately from the vial 200. Any mechanism for achieving this result may be employed. In presently preferred embodiments, the plunger assembly 1210 may be configured to use mechanical force, such as pistons or other mechanical devices, to directly contact the proximal gaskets 330. For example, in one embodiment, the plunger assembly 1210 includes a plunger plate 1240 coupled to a plurality of pistons 1260 positioned to fit into the vial 200. The radially extending plunger plate 1240 provides a grip for a user, while a plunger spring 1250 maintains the plunger assembly 1210 in a relaxed state. In other embodiments, the plunger assembly may be configured to use pneumatic or hydraulic pressure.

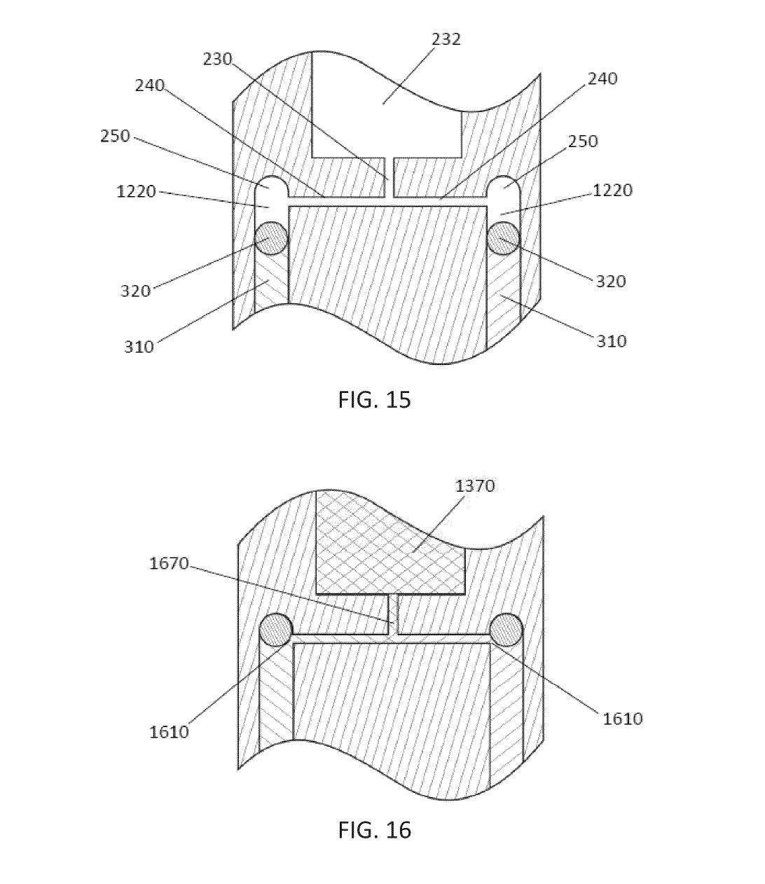

The number of pistons 1260 on the plunger assembly 1210 corresponds to the number of storage lumens 260 in the vial 200. In one embodiment, each of the pistons 1260 is aligned with one of the storage lumens 260. In another embodiment, each of the storage lumens 260 receives a single piston 1260 at the proximal end 212. When the plunger assembly 1210 is fully relaxed, as illustrated in FIG. 12, the storage lumens 260 include an initial proximal dead space 1230. The proximal dead space 1230 is an open area of the storage lumens 260 between the proximal gaskets 330 and the pistons 1260 positioned within the storage lumens 260. A distal dead space 1220 is also present in the storage lumens 260. As best seen in FIG. 15, the distal dead space 1220 is an open area of the storage lumens 260 between the distal gaskets 320 and the seats 250. The proximal dead space 1230 and the distal dead space 1220 allow for any thermal expansion of the analytic reference material subunits 310 within the storage lumens 260 that may occur during transport or storage. The proximal dead space 1230 and the distal dead space 1220 are typically occupied by a gas or liquid, but can be occupied by any substance or combination of substances allowing for thermal expansion.

As the plunger plate 1240 is depressed (FIG. 13), the plunger spring 1250 is compressed and the pistons 1260 slide axially further into the storage lumens 260, contacting the proximal gaskets 330. The pistons 1260 displace the proximal dead space 1230 and move the analytic reference material subunits 310, and the distal gaskets 320, towards the distal end 214. As the plunger plate 1240 is further depressed, the pistons 1260 slide further into the storage lumens 260. The pistons 1260 push the proximal gaskets 330 which in turn push the analytic reference material subunits 310. It is preferred, but not required, that the entire space within the storage lumen 260 between the proximal and distal gaskets 330, 320 is completely filled with the particular analytical reference material subunit 310 and is free of air gaps or bubbles. The analytic reference material subunits 310 push the distal gaskets 320 past the transfer channel 240 and into the gasket seats 250. A channel gap 1610 (as better seen in FIG. 16) is formed between the distal gaskets 320 and the transfer channel 240. The channel gap 1610 allows analytic reference material subunits 310 to flow past the distal gaskets 320 and into the transfer channel 240. In the transfer channel 240, the analytic reference material subunits 310 combine to form a combined stream 1670. The combined stream 1670 flows from the transfer channel 240 into the mixing channel 230 and then into the common chamber 232 to create the combined analytical reference material 1370.

Referring to FIG. 14, the plunger plate 1240 is fully depressed, compressing the plunger spring 1250. The pistons 1260 are fully deployed, pressing the proximal gaskets 330 against the distal gaskets 320. The distal gaskets 320 are fully seated in the seats 250, completely displacing the distal dead space 1220 and maximizing the volume of analytic reference material subunits 310 transferred. The transfer channels 240, mixing channel 230, storage lumens 260 and gasket seats 250 are configured to minimize liquid dead volume following deployment of the standard solutions. In order to ensure consistent final concentrations of the mixed solutions, the transfer channel 240 is preferably designed in a symmetrical pattern so that the dead volumes of each individual solution subunit 310 retained in the vial are equivalent. While some volume of untransferred analytic reference material subunits 310 will remain fugitive within the transfer lines of the vial, the design generally ensures that it does so in a manner that minimizes that volume and that retains the relative proportions of the analytic reference material subunits 310.

The total contents of subunits 310 transferred into common chamber 232 form a predetermined analytical reference solution based upon the individual components independently included as subunits 310 in the plurality of storage lumens 260. It is not a requirement that the common chamber 232 is empty prior to transferring analytic reference material subunits 310. For those skilled in the art it is often desirous to dilute the combined analytical reference material 1370 in follow-on processes. It is possible to achieve an in-situ dilution of combined analytical reference material 1370 if additional liquid or solvent (not shown) is preloaded in common chamber 232 prior to transferring the analytic reference material subunits 310.

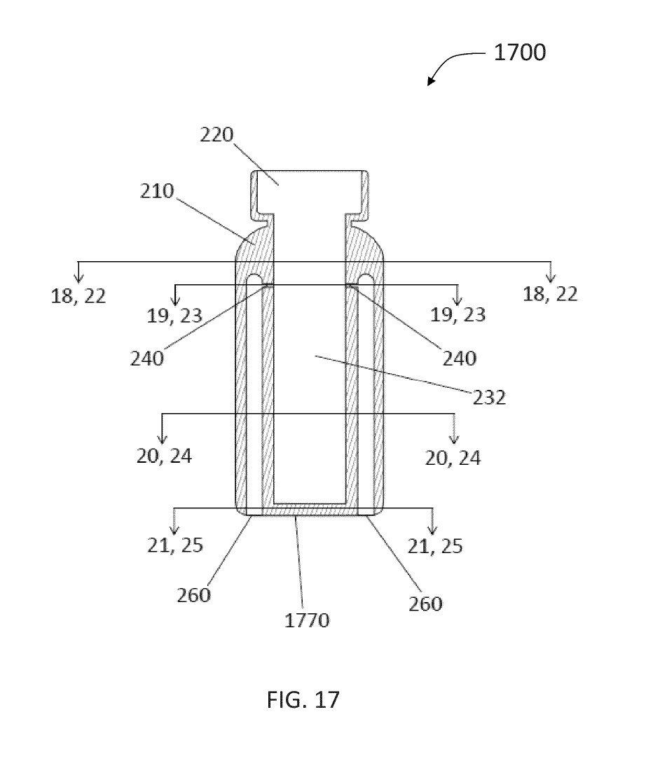

In one embodiment, as illustrated in FIG. 17, the common chamber 232 of a vial 1700 traverses the entire length of the center of the vial 1700 to the vial floor 1770. In another embodiment, the storage lumens 260 are in liquid communication with transfer channels 240, which in turn empty directly into common chamber 232. In a further embodiment, mixing of the analytic reference material subunits 310 is achieved by agitating the combined analytic reference material subunits 310 in the common chamber 232 of the vial 1700. In this design the common chamber 232 of the vial 1700 is larger than in previous examples, and whose dimensions may be more compatible with commercially available automated vial handling and sampling systems.

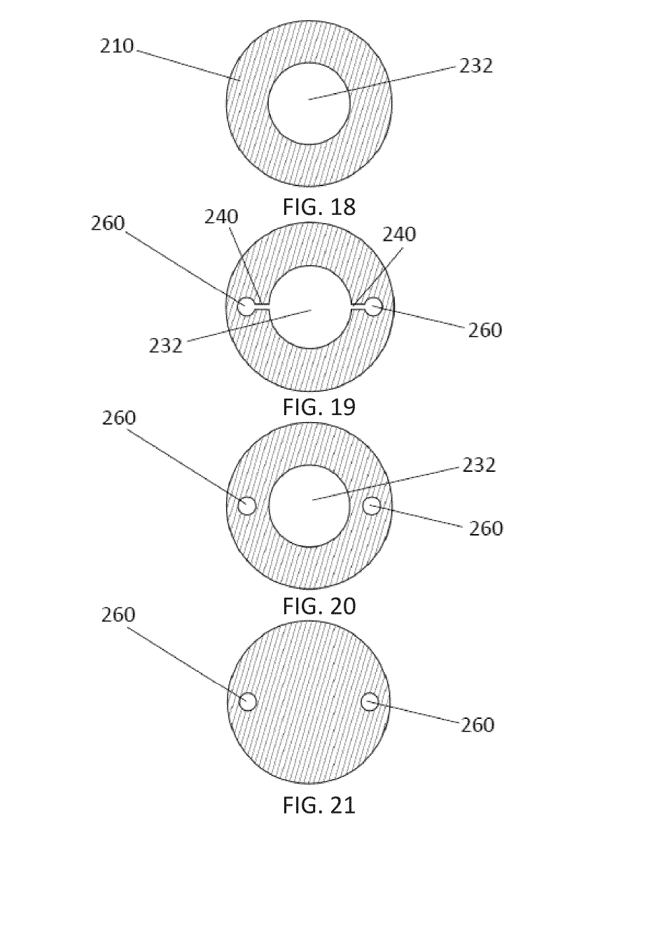

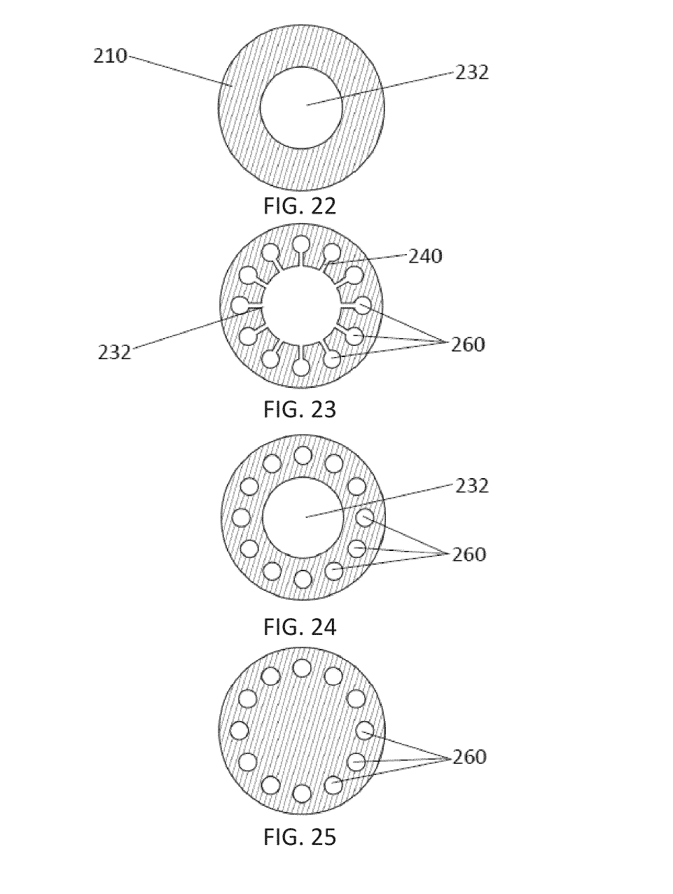

Turning to FIGS. 18-21, in one embodiment, the vial 1700 includes two of the individual storage lumens 260. In another embodiment, as illustrated in FIGS. 22-25, the vial 1700 includes twelve of the individual storage lumens 260. Although illustrated with two or twelve of the lumens 260, it will be appreciated by those skilled in the art that the vial 1700 is not so limited, as discussed above with regard to the vial 200. The cross-sectional views shown in FIGS. 18-21 and 22-25 are taken from the same position along the vial body 210 shown in FIG. 17. Specifically, FIGS. 18 and 22 show a cross-section of the common chamber 232 near the distal end 214 of the vial 1700; FIGS. 19 and 23 show a cross-section of the transfer channels 240 emptying directly into the common chamber 232; FIGS. 20 and 24 show a cross-section of the transfer channels 240 extending axially and adjacent to the common chamber 232; and FIGS. 21 and 25 show a cross-section of the storage lumens 260 near the proximal end 212 of the vial 1700.

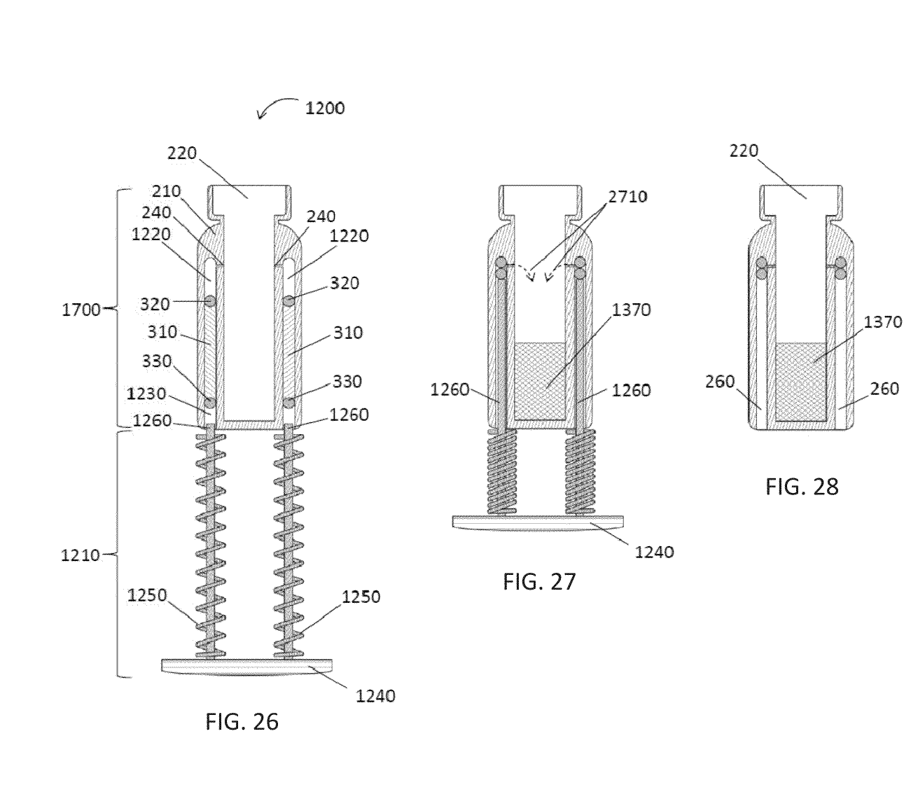

Referring to FIGS. 26-28, in this design, the transferring and containing device 1200 includes the vial 1700 engaged with the plunger assembly 1210. The transfer of subunits 310 to the transfer channels 240 is achieved in a similar fashion as described in FIGS. 12-14. However, instead of entering the mixing channel 230 (FIG. 2) from the transfer channels 240, the analytic reference material subunits 310 enter the common chamber 232 directly from the transfer channels 240.

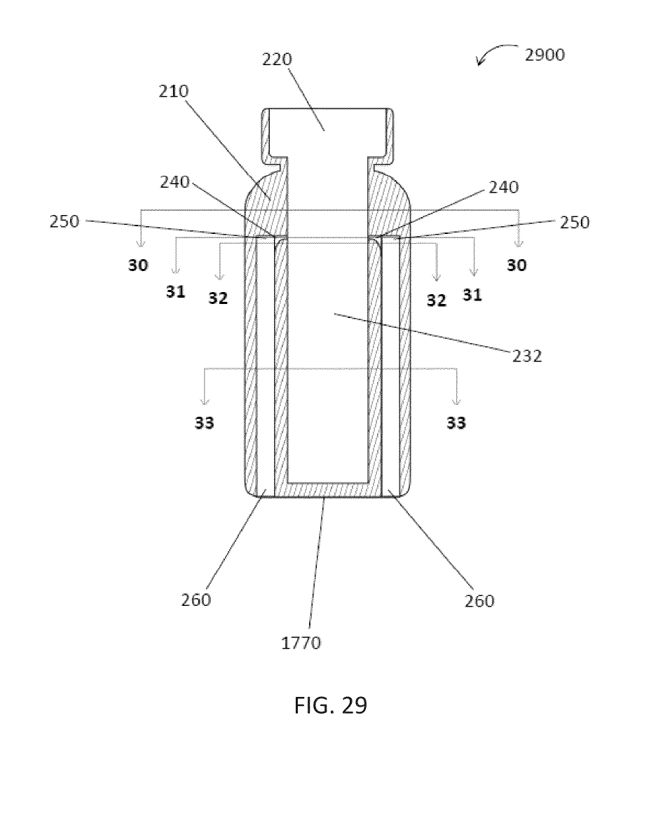

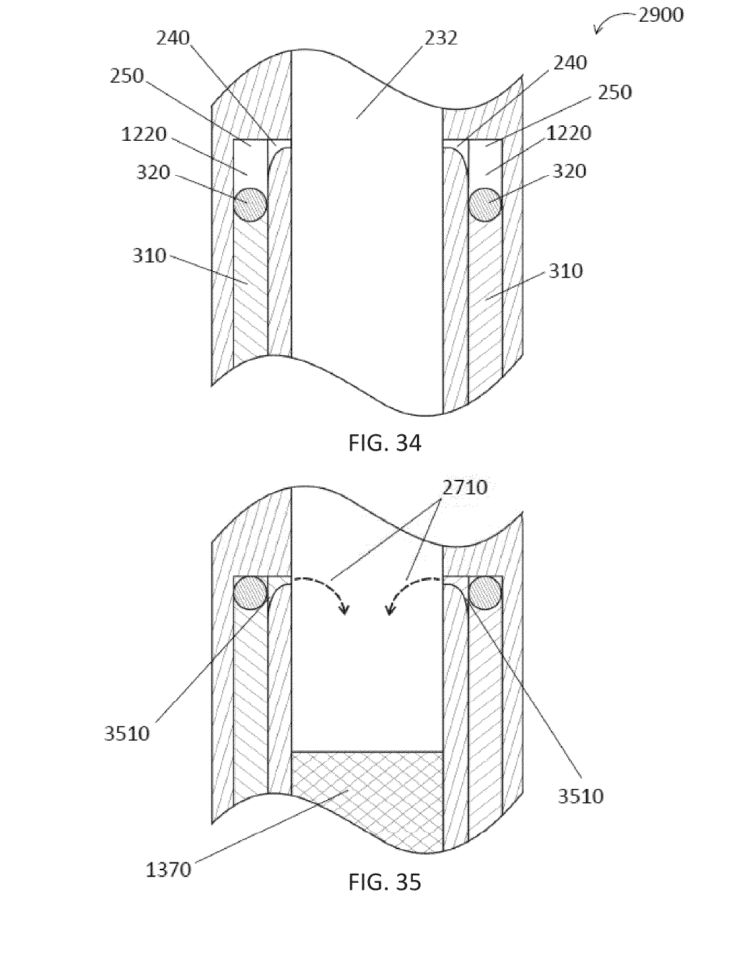

In another embodiment, a groove or channel is cut into a portion of the storage lumen 260, the groove or channel connecting the storage lumen 260 to the transfer channel 240. For example, as illustrated in FIG. 29, the transfer channels 240 of a vial 2900 may be tapered and positioned in-line with the gasket seats 250. As distal gaskets 320 (see FIGS. 34-35) advance, they displace the distal dead space 1210 and become seated in the gasket seat region 250. Concurrent with this step, a channel gap 3510 is generated, the channel gap 3510 providing liquid communication of the analytic reference material subunits 310 between the storage lumens 260 and the transfer channels 240. As proximal gaskets 330 continue to advance, the analytic reference material subunits 310 pass through the transfer channels 240 and into common chamber 232 where they may be mixed through shaking or other means of agitation of the vial 2900. Due to the channel gap 3510 formed by the tapered portion of the transfer channels 240, a size of the gasket seat region 250 may be decreased while still allowing the analytic reference material subunit 310 to bypass the distal gasket 320. The decreased size of the gasket seat 250 decreases a manufacturing complexity of the vial 200.

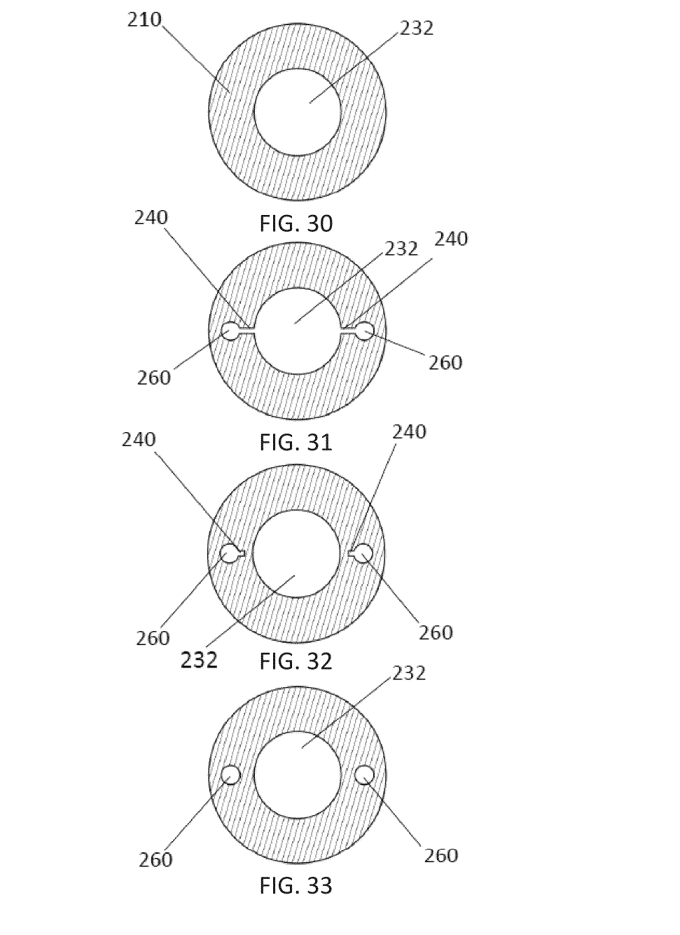

Turning to FIGS. 30-33, in one embodiment, the vial 2900 includes two of the individual storage lumens 260, twelve of the individual storage lumens 260, or any other suitable number of storage lumens 260 for forming the analytic reference material. Although illustrated with two of the lumens 260, it will be appreciated by those skilled in the art that the vial 2900 is not so limited, as discussed above with regard to the vial 2900. The cross-sectional views shown in FIGS. 30-33 are taken along the cross-sectional lines shown in FIG. 29. Specifically, FIG. 30 shows a cross-section of the common chamber 232 near the distal end 214 of the vial 2900; FIG. 31 shows a cross-section of the transfer channels 240 emptying directly into the common chamber 232; FIG. 32 show a cross-section of a tapered portion of the transfer channels 240 extending axially and adjacent to the common chamber 232; and FIG. 33 shows a cross-section of the storage lumens 260 near the proximal end 212 of the vial 2900.

This design has some advantages relating to the manufacture of the vial; where the vial body 210 is manufactured by fusing two halves together essentially along the surface of radial cross section 19, 23. It will be appreciated that the transfer channel 240 may be any shape or configuration where the steps of seating the distal gaskets 1720 and generating the channel gap 3510 are achieved. As in the other embodiments described herein, it is possible to achieve an in-situ dilution of combined analytical reference material 1370 if additional liquid or solvent is preloaded in common chamber 232 prior to transferring the analytic reference material subunits 310 (not shown).

Although described herein primarily with respect to analytic reference materials, it will be appreciated that exemplary embodiments are contemplated for, and equally effective for use in, other applications in which two or more fluids are preferably isolated prior to mixing, but conveniently can be collectively stored and subsequently contained to the same point of use. For example, the multilumen vial 200 may be used for liquid medicaments, pigments, chemical additives, and/or adhesives, all by way of example.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A device for transferring and containing liquid material, comprising:
a vial having at least two storage lumens extending axially along a vial body, each of the storage lumens having a gasket seat formed therein;
a transfer channel coupled to a distal end of each of the storage lumens; and
a common chamber in fluid communication with the storage lumens via the transfer channels.

2. The device of claim 1, further comprising a mixing channel coupling the transfer channels to the common chamber.

3. The device of claim 1, further comprising a plunger assembly coupled to a proximal end of the vial in communication with the storage lumens.

4. The device of claim 3, wherein the plunger assembly comprises at least two pistons, each of the pistons receivable within one of the storage lumens.

5. The device of claim 3, wherein the plunger assembly comprises a working fluid transferring and containing apparatus in fluid communication with the storage lumens.

6. The device of claim 1, wherein each of the storage lumens has a diameter equal to the others.

7. The device of claim 1, wherein each of the storage lumens are equidistant from the common chamber.

8. The device of claim 1, comprising an analytic reference material subunit provided in at least two of the storage lumens.

9. The device of claim 8, wherein the analytic reference material subunit in at least one of the storage lumens is chemically incompatible with the analytic reference material subunit in at least one other storage lumen.

10. The device of claim 8, wherein each of the storage lumens has a proximal gasket sealing the analytic reference material subunit from a proximal end of the vial and a distal gasket sealing the analytic reference material subunit from a distal end of the vial.

11. The device of claim 10, wherein each of the storage lumens includes a gasket seat formed therein, the gasket seat arranged and disposed to receive the distal gasket.

12. The device of claim 10, wherein the distal gasket has a diameter larger than a diameter of the storage lumens.

13. The device of claim 10, wherein the proximal gasket and the distal gasket are constructed of polytetrafluoroethylene.

14. The device of claim 10, wherein the proximal gasket and the distal gasket are spherical.

15. A device for transferring and containing liquid material, comprising:
a vial having at least two storage lumens extending axially along the vial body, each of the storage lumens including a gasket seat formed therein;
a transfer channel coupled to a distal end of each of the storage lumens;
a common chamber in fluid communication with the storage lumens via the transfer channels;
a plunger assembly coupled to a proximal end of the vial, the plunger assembly having at least two pistons, each of the pistons receivable within one of the storage lumens; and
an analytic reference material subunit provided in each of the storage lumens, the analytic reference material subunit sealed between a proximal gasket and a distal gasket slidably disposed within the storage lumens;
wherein when the distal gasket is seated in the gasket seat, the transfer channel fluidly connects the analytic reference material subunit of the storage lumen to the common chamber.

16. The device of claim 15, further comprising a proximal dead space in the storage lumens intermediate the proximal gasket and the storage lumen's corresponding piston and a distal dead space in the storage lumens intermediate the distal gasket and the distal gasket seat.

17. The device of claim 15, wherein the storage lumens have a diameter of up to 0.25 inches.

18. The device of claim 14, wherein a volume between the common chamber and each storage lumen is identical.

19. The device of claim 14, wherein the storage lumens are equidistant from the common chamber.

20. A mixing method, comprising:
providing the device of claim 1, each of the storage lumens in the device including a distal gasket positioned therein;
providing a fluid subunit in each of the storage lumens, the distal gasket sealing each of the fluid subunits from a distal end of the vial;
providing a plunger assembly coupled to a proximal end of the vial, the plunger assembly being in communication with the storage lumens; and
depressing the plunger assembly;
wherein the depressing of the plunger assembly forces the distal gaskets into the gasket seats and transfers the fluid subunits into the common chamber via the transfer channels.
